(19) United States
(12) Patent Application Publication
(10) Pub. No.: US 2014/0285806 A1
(43) Pub. Date: Sep. 25, 2014

(54) CA

(71) Applicant: Alfred M. Haas, Oakhurst, NJ (US)

(72) Inventor: Alfred M. Haas, Oakhurst, NJ (US)

(21) Appl. No.: 14/215,026

(22) Filed: Mar. 16, 2014

Related U.S. Application Data
(60) Provisional application No. 61/786,429, filed on Mar. 15, 2013.

(51) Int. Cl. G01J 3/52; G01J 3/50; G01J 3/46

(52) U.S. Cl. CPC G01J 3/522; G01J 3/463; G01J 3/50
USPC 356/406; 356/421

(57) ABSTRACT

The instant invention relates to methods and means for calibrating and matching colors and light. Some embodiments of the methods and means of the invention also incorporate additional functionality including, but not limited to communication, sensing, display and data processing elements. Various embodiments of the methods and means of the invention may be performed by and/or implemented in hardware, in software, by one or more entities, and/or by some combination of hardware, software and/or one or more entities.

### CROSS-REFERENCE TO RELATED APPLICATIONS

Pursuant to 35 USC §119(e) and as set forth in the Application Data Sheet, this utility application claims the benefit of priority from U.S. Provisional Patent Application No. U.S. 61/786,429 (“the '429 provisional”) which is incorporated herein in its entirety by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention claims priority from the '429 provisional and expressly incorporates by reference the disclosures contained therein in their entirety, including but not limited to all patents, patent applications, and publications which are incorporated by reference in the '429 provisional and which are incorporated by reference herein in their entirety.

In the context of the instant disclosure, the term “software” is taken in the broadest sense of its ordinary meaning and illustrative examples may comprise, but are not limited to, one or more of the following: realized embodiments of algorithms in any form, code written in whole or in part in any programming, scripting or other language (including, but not limited to, popular languages such as C++, Java, Visual Basic, Python, PHP, HTML, and/or device specific machine or assembly languages, etc. . . . ), programs, mobile and/or other applications (e.g., those for Android and iOS based systems), applets, scripts, operating systems (OS) and components of OS, embedded and other software and instructions, structured data, op codes, commands, executables, firmware, drivers, virtual machines, and/or instruction sets for a system. Software may operate at many levels including, but not limited to, over a distributed system (e.g., on a cloud computing or mobile network), on a particular device, on a local computer or other machine, embedded in an ASIC or other circuit, and running on top of one or more real or virtual levels, including but not limited to an OS and a hardware level.

In the context of the instant disclosure, the term “hardware” is taken in the broadest sense of its ordinary meaning and illustrative examples may comprise, but are not limited to, one or more of the following: smart and other scales, computers, smart phones, PDAs, other commercially available electronic devices such as tablet PCs, netbooks, e-readers (e.g., Kindle™ and Nook™), pagers, alarms, beepers, cell phones, hearing aids, watches comprising integrated and/or discrete circuits, monitors and displays, televisions, calculators, iPods™ and MP3 players, radios and stereos, remote controls, bar code readers, keyboards, cameras, other input devices, data acquisition systems, other physical devices and systems comprising integrated and/or discrete circuits, CPUs, hard drives, flash USB drives, other flash and solid state drives, programmable logic arrays, FPGAs, CPLDs, microcontrollers, DSPs, receivers, transmitters, drivers, ADC's (analog-to-digital converters), DAC's (digital-to-analog converters), decoders, multiplexers, comparators, latches, gates, op amps, LNA (low noise amplifiers), PLL (phase locked loops), antennae, radio frequency identification (“RFID”) devices, near-field communication (“NFC”) devices, coils, capacitors, inductors, resistors, transformers, solenoids, other analog circuits and components, other digital circuits and components, other mixed-signal circuits and components, optical circuits, other electromagnetic circuits and components, biological and/or chemical circuits, assemblies of memristors, carbon nanotubes, and other circuits and systems comprised of circuits.

Some embodiments of the methods and means of the instant invention may employ one or more existing wireless and/or wired communication protocols, or other custom protocols. Illustrative examples of current and historical protocols, programs and standards for digital communication include: the Internet Protocol Suite; e-mail protocols such as POP (Post Office Protocol), SMTP (Simple Mail Transfer Protocol), IMAP (Internet Message Access Protocol), and MAPI (Messaging Application Programming Interface); web browsers such as Safari™, Internet Explorer™ and Firefox™; messaging programs, protocols and standards such as WLM (Windows Live Messenger), MSNP (Microsoft Notification Protocol), AIM (AOL Instant Messenger), ICQ, XMPP (Extensible Messaging and Presence Protocol), IRC (Internet Relay Chat), MIM (Mobile Instant Messaging), SMS (Short Message Service), WAP (Wireless Area Protocol), GPRS (General Packet Radio Service), WLAN (Wireless Local Area Network), Bluetooth™, and Skype™; mobile standards such as GSM (Global System for Wideband Communications), W-CDMA (Wideband Code Division Multiple Access), LTE (Long Term Evolution), and LTE-Advanced, WirelessMAN (Metropolitan Area Networks)-Advanced; NFC (near-field communications), and many others not addressed here. To the extent that documented versions of these protocols, programs and standards are publicly accessible they are incorporated herein by reference. Likewise, some embodiments of the methods and/or means of the instant invention may employ analog and/or mixed-signal methods of communicating data or information. In addition, some embodiments of the invention employ GPS (Global Positioning System) and aGPS (Assisted Global Positioning System) protocols and/or standards.

The following publications and software packages contain information related to the design, development, fabrication, production, assembly, and other aspects of some embodiments of the disclosed invention—including, but not limited to, wearable and other mobile devices, software and hardware such as sensors and transducers, transmitters, receivers and other circuits, housings, optics. programmable logic elements and chips, custom ASICs, electrical and mechanical switches, electrical and mechanical regulators, etc.: Lange's Handbook of Chemistry, Fifteenth Edition, edited by John R. Dean, published by McGraw-Hill, copyright 1999; Hawley's Condensed Chemical Dictionary, Thirteenth Edition, revised by Richard J. Lewis, Sr., published by John Wiley & Sons, copyright 1997; Organic Chemistry, Third Edition, by G. Marc Loudon, published by The Benjamin/Cummings Publishing Company, copyright 1995; Chemical Separations and Measurements: The Theory and Practice of Analytical Chemistry, Dennis G. Peters, John M. Hayes, Gary M. Hieftje, published by W.B. Saunders Company, copyright 1974; Physical Chemistry, Seventh Edition, by Robert A. Alberty, published by John Wiley & Sons, copyright 1987; Principles of Neural Science, Fourth Edition by Kandel, Schwartz, and Jessell, published by McGraw-Hill, copyright 2000; Introduction to Modern Optics, second edition by Grant R. Fowles, published by Dover Publications, Inc., copyright 1975; Analysis and Design of Analog Integrated Circuits by Paul R. Gray, Paul J. Hurst, Stephen H. Lewis, Robert G. Meyer, published by John Wiley & Sons, copyright 2001; Digital Principles and Design by Donald D. Givone, published by McGraw Hill copyright 2003; Physics by Paul A. Tipler, published by Worth Publishers, copyright 1976; The New Way Things Work by David Macaulay, published by Houghton Mifflin, copyright 1988; CMOS Circuit Design, Layout and Simulation by R. Jacob Baker, published by the Institute of Electrical and Electronics Engineers, copyright 2005; Microelectronic Circuits by Adel S. Sedra and Kenneth C. Smith, published by Oxford University Press, copyright 1998; Thin Film Technology Handbook by Aicha Elshabini-Riad, Fred D. Barlow III, published by McGraw-Hill, copyright 1998; Field and Wave Electromagnetics by David K. Cheng, published by Addison-Wesley, copyright 1989; VLSI for Wireless Communications by Bosco Leung, published by Prentice Hall, copyright 2002; Complete Wireless Design by Cotter W. Sayre, published by McGraw Hill, copyright 2001; Pattern Classification, Second edition by Richard Duda, Peter Hart and David Stork, published by John Wiley & Sons, Inc., copyright 2001; C++ How to Program, Third edition by H. Dietel & P. Dietel, published by Prentice Hall, copyright 2001; Professional Android 2 Application Development by Roto Meier, published by Wiley Publishing, Inc., copyright 2010; the various versions of the Android SDK; the various versions of the Internet Protocol Suite; the various versions of the iOS SDK; the various versions of the Windows and Windows Mobile SDKs. All publications cited herein are hereby incorporated by reference in their entirety.

The discussion of the background of the invention herein is included to explain the context of the invention. Although each of the patents, patent applications, and publications cited herein are hereby incorporated by reference, neither the discussion of the background nor the incorporation by reference is to be taken as an admission that any aspect, element, embodiment, or feature of the invention was published, known, or part of the common general knowledge as of the priority date of any claims of the invention.

### BRIEF SUMMARY OF THE INVENTION

The instant invention relates to methods and means for calibrating and matching colors. In some embodiments, methods and means of the invention relate to paint and painting. In some embodiments, methods and means of the invention relate to cosmetics. In some embodiments, methods and means of the invention relate to the measurement and analysis of light. Light in the context of the instant invention may comprise any form of detectable electromagnetic radiation, although when we speak of color matching and color calibration we are referring to light we perceive with our eyes.

### BRIEF DESCRIPTION OF THE SEVERAL VIEWS OF THE DRAWINGS

FIGS. 1-3 illustrate schematic examples of color cards according to some embodiments of the instant invention.

FIG. 2 A-C schematically illustrates some examples of embodiments of the instant invention. In FIG. 2A, a user is using a digital camera to capture an image of a color card and a wall. In FIG. 2B a user is employing a cell phone comprising an integrated APS image sensor and a custom software application to calibrate and normalize a photograph according to ambient illumination conditions and cached color standards. In FIG. 2C, a user is taking a photograph of a woman's fingernail polish while that woman's hand is atop a table comprising a color card.

FIG. 3 is a copy of a digital photograph of an example of a color card according to some embodiments of the instant invention.

FIG. 4 is a copy of a processed and altered digital photograph of an example of a color card according to some embodiments of the instant invention.

### DETAILED DESCRIPTION OF THE INVENTION

The instant invention relates to methods and means for calibrating and matching colors and light. Some embodiments of the methods and means of the invention also incorporate additional functionality including, but not limited to communication, sensing, display and data processing elements.

In some specific embodiments of the methods of the instant invention, a user places a color card onto, atop or in contact with an object or proximate region of a surface that he wishes to color match and then photographs the color card and object or surface together. In some such embodiments, if the photograph is taken using photographic or other film, the resulting transduced image may be digitized; in some embodiments, if the camera is digital, the transduced image may already be digitized.

In the context of the instant invention, we define a “color card” as a discrete physical substrate onto which one or more colors have been disposed, painted, coated, dyed or otherwise imbued. We sometimes refer to “color cards” as “cards.” A color card may comprise but is not limited to one or more of the following, paper, cardboard, ceramic, clay, cloth, crystal, fabric, fur and/or animal hide—e.g. leather, glass, metal and metal alloys (e.g. gold, silver, platinum, tin, aluminum, steel, stainless steel, iron, copper, and titanium), wood, rubber, other organic and/or synthetic polymer, Velcro, plastic (e.g. ABS, poly lactic acid, polyethylene), silicone, stone, and other natural and composite materials (e.g. carbon fiber). In some of the figures and photographs of prototypes of some embodiments of the invention, cards are shown as a single piece of material, although cards according to various embodiments of the instant invention may be assembled, formed, molded, cast, printed, carved, etched, milled, poured, or otherwise fabricated in more than one piece. In some embodiments, all or part of a card may be conformal, flexible, malleable, moveable, pliable, plastic, rubbery, and/or stretchable. In some embodiments of the invention, a color card may be adhered, applied, assembled, cast, carved, coated, colored, configured, decorated, dyed, embroidered, manufactured, milled, shaped, stained, painted, pigmented, stitched, cut, deposited, embossed, extruded, formed, glued, layered, melted, milled, molded, painted, poured, pressed, printed, rolled, rubbed, sculpted, sprayed, squeegeed, stamped, stuck, taped, textured, shaped and/or otherwise formed and/or disposed onto a surface, substrate and/or a device. In some embodiments, cards may be coated in whole or in part with adhesives comprising, but not limited to, contact adhesives, drying adhesives such as Elmer's™ glue, epoxies, hot melt and/or heat activated adhesives, polymer adhesives such polyvinyl acetate, pressure sensitive adhesives, rubber cement, silicone based adhesives, and other natural and synthetic adhesives.

In some embodiments, a card may comprise a filter, for example a filter to attenuate the transmission of one or more wavelengths of light. In some embodiments, filters may comprise absorption filters; in some embodiments, filters may comprise interference filters; in some embodiments, filters may comprise some combination of absorption and/or interference filters. In some embodiments, filters may comprise one or more compositions and/or materials that reflect and/or refract light. In some cases, a card may comprise one or more patterns. As one specific example, a color card might comprise a substantially transparent substrate comprising an overlaid, etched, or embedded visible grid which might be useful e.g. in partitioning regions of images taken using the filter grid. In some embodiments, a color card may comprise image registration features to assist in aligning, orienting, and/or positioning something. Some embodiments of the invention may comprise a microscope comprising a cell phone camera and one or more lenses. In some embodiments, a color card may comprise one or more materials that are opaque, transparent, translucent, and/or transmit some light.

In some embodiments, a color card may be applied, placed and/or otherwise disposed onto a surface, for example the lens or glass on top of the lens of a cell phone camera. In some embodiments, a color card may be conformally disposed onto a surface and/or may comprise a conformal lining and/or coating (e.g. silicone rubber or other polymer layer) that may be layered onto (e.g. by spraying, deposition, extrusion, immersion or by “dunking”—i.e. submerging in for example polymer, by molding, by painting, by pouring, by painting, by printing, by spraying, etc. . . . ) a surface. In some embodiments, color cards may comprise more than one layer; in some embodiments one or more layers comprising a color card may be nested; and in some embodiments color cards may be peeled off or otherwise removed and recycled or disposed after one or more uses. In some embodiments, a color card may be mechanically, chemically, and/or physically attached, connected and/or bonded to a surface, for example comprising a device. In some embodiments, a color card may comprise adhesives and/or be attached to a surface or device using adhesives. Illustrative examples of adhesives according to some embodiments of the instant invention include, but are not limited to, contact adhesives, drying adhesives, epoxies, hot melt and/or heat activated and/or light activated or cured adhesives, polymer adhesives such polyvinyl acetate, pressure sensitive adhesives, rubber cement, silicone based adhesives, and other natural and synthetic adhesives. In some embodiments of the invention, a color card may comprise a means for attachment to a device, for example an elastic band.

In some embodiments, means for absorbing, attenuating, blocking, occluding, reflecting and/or otherwise filtering light, and/or for blocking transmission of a signal or disconnecting power may comprise hardware and/or software. In some embodiments, a color card may comprise an active hardware means capable of absorbing, attenuating, blocking, occluding, reflecting and/or otherwise filtering one or more wavelengths of light. For example, in some embodiments, active hardware means comprise a device comprising liquid crystals (“LQ”). A LQ device may significantly attenuate the transmission of one or more wavelengths of light when oriented in one or more electric fields according to some embodiments of the invention, and may be substantially transparent either in the absence of such fields or when oriented differently according to a different electric field. Other illustrative examples materials capable of absorbing, attenuating, blocking, occluding, reflecting and/or otherwise filtering one or more wavelengths of light when an electric field, potential, charge and/or current is applied, and which may comprise color cards, include, but are not limited to the following: OLEDs (organic light emitting diodes) like those found in some modern cell phones; thin film transistors; incandescent lights; light emitting diodes; lasers; voltage sensitive dyes and other color-changing polymers; pigmented fluids, solutions and mixtures, functionalized micro-beads, and e-inks. Many of these technologies also are capable of generating light. In some embodiments a color card may comprise a means for generating light. Some embodiments of methods of the invention may comprise turning on a light source (e.g. a laser diode) to completely or partially saturate an image sensor thereby obscuring or attenuating an incident image. In some embodiments of the instant invention, a filter may comprise a means, for example a display, for creating registration features, logos, watermarks, or other patterns.

In some embodiments, color cards comprise regions colored according to the principal elements of a color scheme—e.g. some cards comprise red, green and blue regions; in some embodiments, color cards comprise cyan, magenta, yellow, and black regions; in some embodiments, color cards comprise primary colors red, blue and yellow; in some embodiments color cards comprise arbitrary color schemes. In some embodiments color cards comprise discrete regions of uniform color; in some embodiments, color cards comprise gradients. In some embodiments, a color card comprises a white region.

In some embodiments, the mapping between the colors on a color card and one or more paint colors is known. In some such embodiments where a color card comprises colors spanning a color spectrum—i.e. sufficient to reproduce any color by mixing one or more of the colors comprising the palette of the color card, for example the primary colors, RGB, CMYK, etc. . . . —it is possible to use the photograph of the color card and object or surface to be matched (“the CMO”) to ascertain the precise mapping between the CMO and an appropriate mixture of paint colors. In some embodiments, this may be accomplished by ascertaining the deviation of the digital representation of colored regions of the color card transduced by the camera from a standard representation of these same colors. The resulting digital representation of the photograph may then be calibrated to correct for deviations from standard and these corrections permit the CMO to be known as referenced to known color standards. Once the CMO is known with reference to known color standards which themselves are mapped to mixtures of one or more paint colors, the CMO may be reproduced with fidelity. In some embodiments, the same basic technique may be applied to ascertaining desired nail polish and cosmetics colors so that one could generate such colors, e.g. by blending custom cosmetics to match a desired shade or hue—and may also be applied to any other color or light calibration situation, for example correcting for ambient light levels in calibrating a television screen.

In this regard, it bears repeating that the methods and the means of the instant invention are not limited to applications involving paint, but instead applicable to any color matching application and beyond. For example, with respect to color matching, a surface to be matched according to the method of the invention might comprise but would not be limited to one or more of the following: an article of clothing, a human being or any portion thereof, one or more layers of makeup on a human being or any portion thereof, one or more layers of nail polish, a painted substrate, one or more layers of paint on a substrate, a region of a wall, a region of a floor, a region of a ceiling, a region of an article of furniture, a region of an appliance, a region of a molding, a region of a bannister, and a vehicle. What do we mean by beyond? A color card might not comprise visible colors or emissions in the visible spectrum—it might comprise a UV, RF, microwave, infrared or other EM standard capable of being detected against a surface to be matched. For example, if one wanted to “match” the surface EM characteristics of a stealth bomber without knowing its composition or underlying structure, one approach might be to fabricate a “color card” comprising materials exhibiting appropriate diffraction, reflection and absorption properties at one or more (possibly programmable/adjustable) wavelengths of light and place it on or in close proximity to the stealth bomber surface, acquire data pertaining to the properties of the bomber surface in relation to the color card standard measurements, and develop an appropriate formula to replicate the desired properties. Ostensibly, a variant on the methods disclosed here could be employed in replicating the properties of simple metamaterials as well.

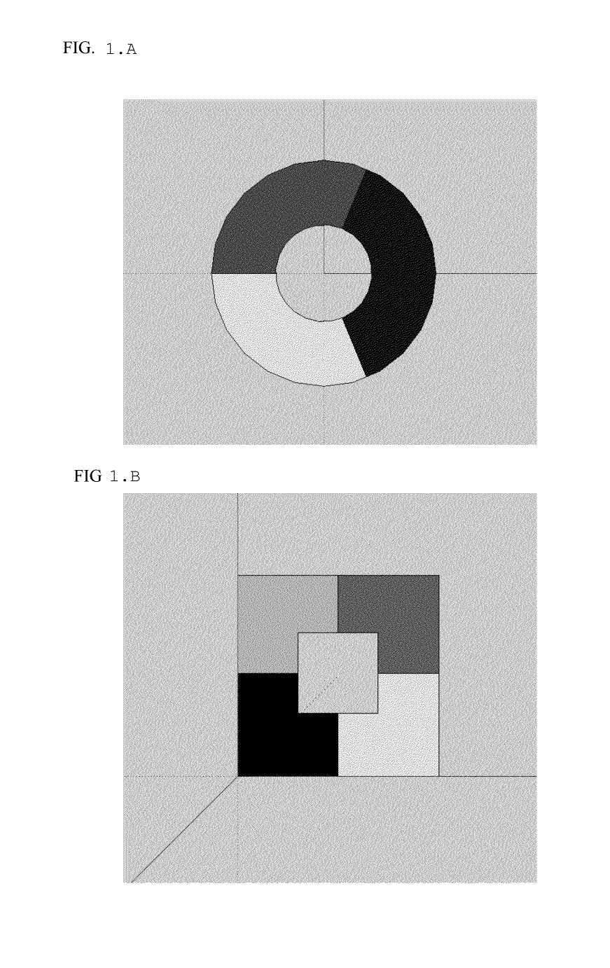

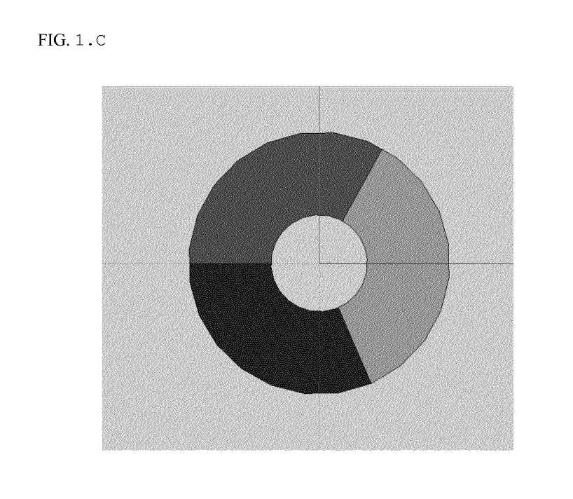

FIGS. 1-3 illustrate several schematic examples of color cards according to some embodiments of the instant invention. These schematics were prepared using Google SketchUp and the barely visible axes are not part of the color cards, nor is the grey background which represents nothing. Note that each of the color cards represented schematically in these figures has an aperture through which a CMO may be visualized. This is not a requirement; some embodiments comprise no such aperture.

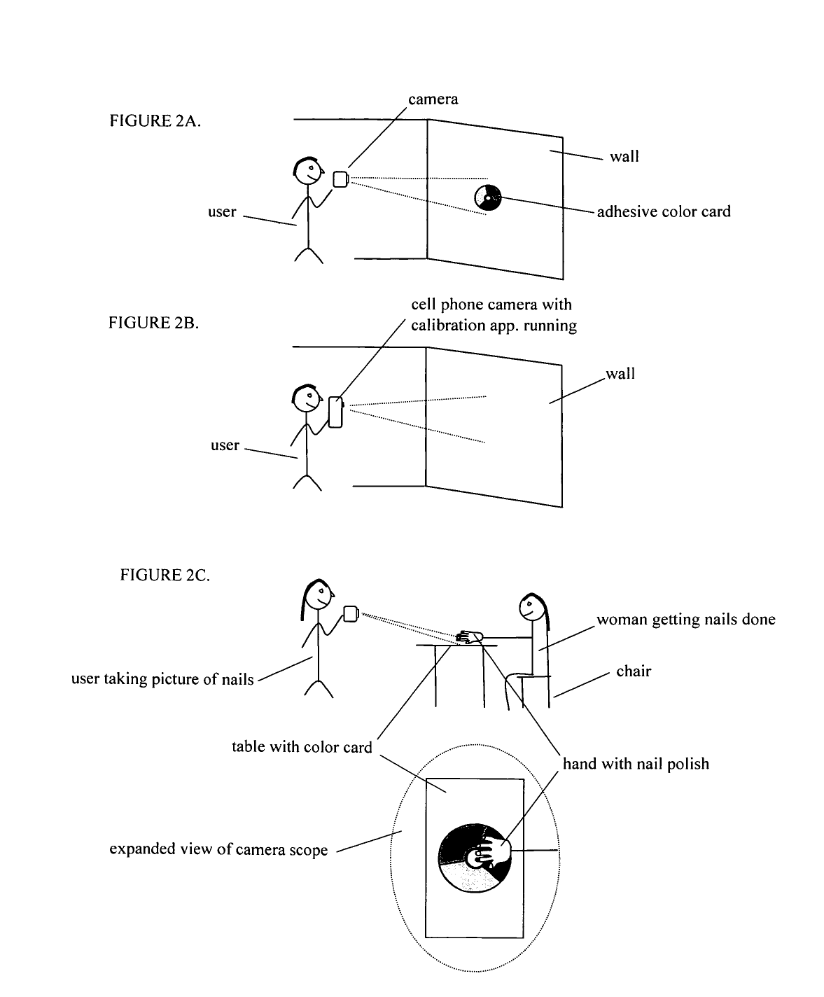

FIG. 2 A-C schematically illustrates some examples of embodiments of the instant invention. In FIG. 2A, a user is using a digital camera to capture an image of a color card and a wall. In FIG. 2B a user is employing a cell phone comprising an integrated APS image sensor and a custom software application to calibrate and normalize a photograph according to ambient illumination conditions and cached color standards. In FIG. 2C, a user is taking a photograph of a woman's fingernail polish while that woman's hand is atop a table comprising a color card.

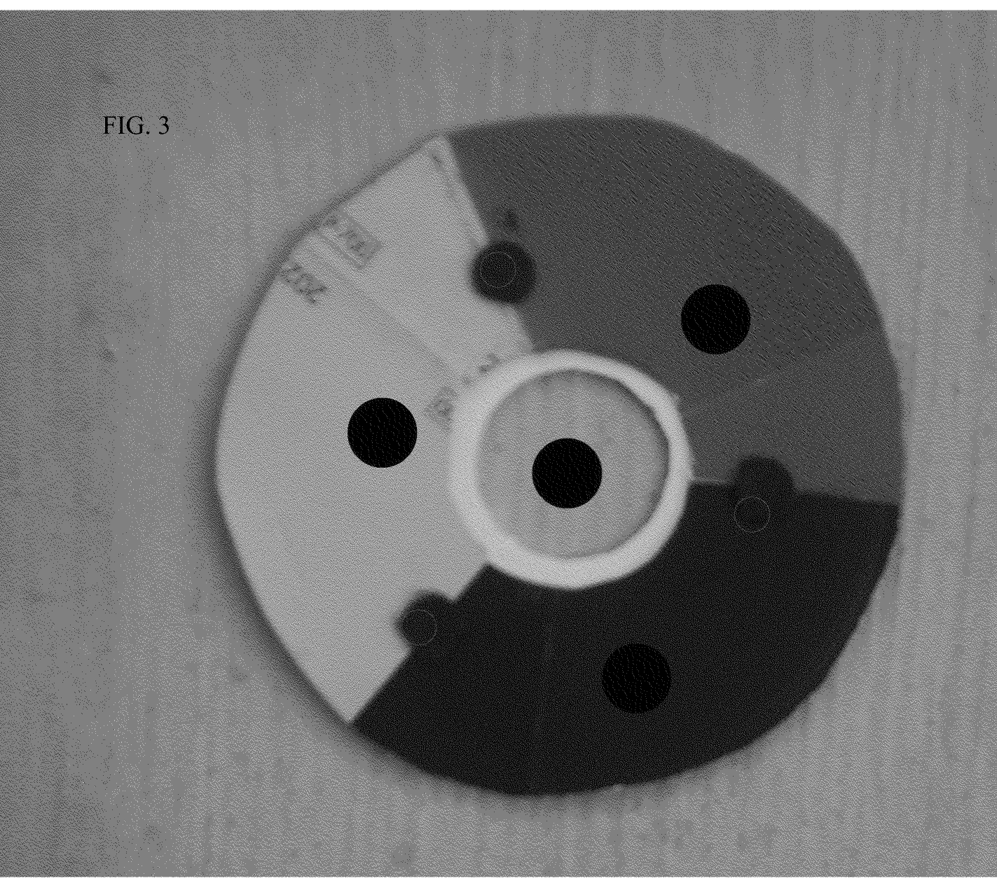

FIG. 3 is a copy of a digital photograph of an example of a color card according to some embodiments of the instant invention. The particular example shown in FIG. 3 comprises the primary colors red, yellow and blue as well as an inner ring of white and 3 black registration marks. The color card in this specific example comprises colored cardstock taken from a paint store (more colloquially known as “paint chips”) and the color card is disposed onto the surface of an exterior wall of a residential home using removable and reusable adhesives

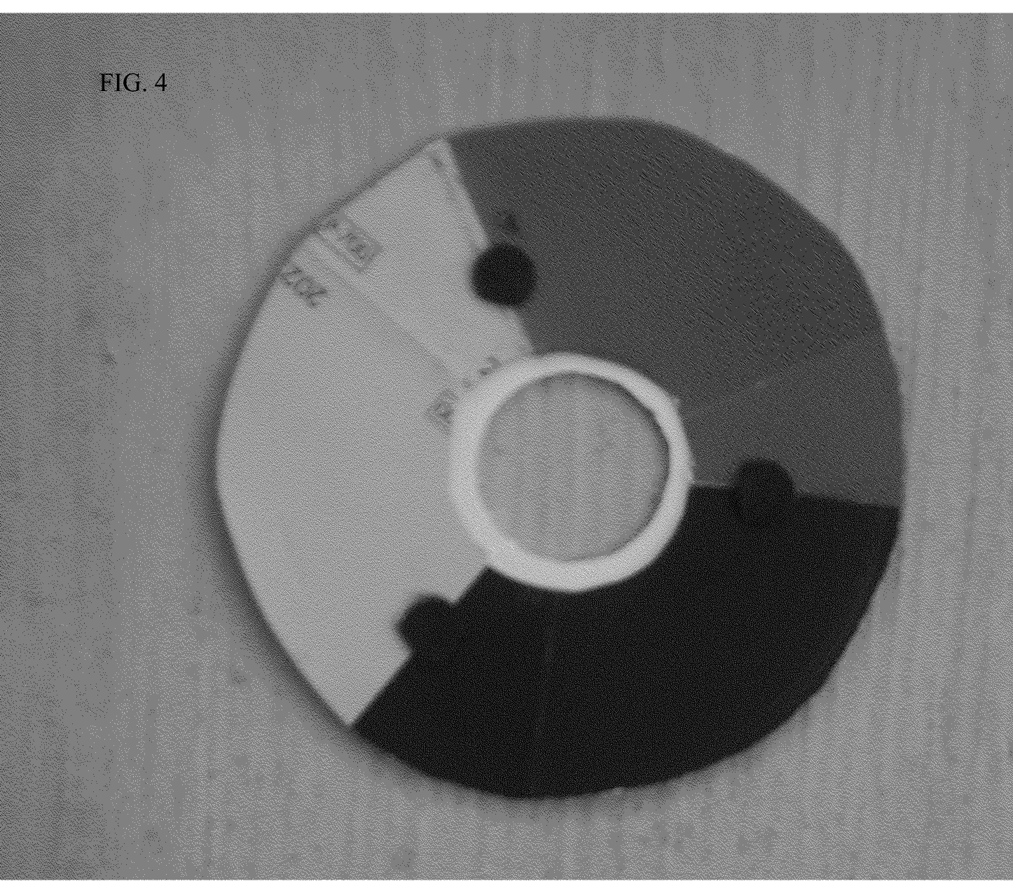

FIG. 4 is a copy of a processed and altered digital photograph of an example of a color card according to some embodiments of the instant invention. In this case, the color card comprises registration marks, which marks have been algorithmically identified. FIG. 4 shows 4 new computer generated black circular marks corresponding with sampled regions of the surface and each of the three analyzed primary colors of the color card.

In the specific examples illustrated by FIGS. 3&4, the inventor acquired images of the color card disposed on the wall using a digital camera, then segmented such images by finding the registration marks within the acquired image frames and using the geometry of the card in conjunction with the image data to locate sampling regions corresponding with a portion of the surface, and areas within the red, yellow and blue and white regions of the color card. In this specific example, the algorithm computed average pixel color values for the sampled image regions and this data was then used to compute a formula for combining the colors of the card to generate a mixture whose color would accurately match that of the surface. Again, with respect to this specific example of an embodiment, several different computational methods were employed in calculating the optimal formula, including but not limited to linear, log-linear, and non-linear methods.

In some embodiments where the mapping between the colors on a color card and one or more paint colors is unknown in advance, the color card may be digitized under controlled conditions at a vendor's establishment using known hardware with known transduction parameters and behavior to map the color card colors under known conditions to paint colors and then the photograph taken by a user to map the color card and CMO to a mixture of one or more such paint colors correspondingly.

In some embodiments, a color card may be digital. For example, a digital camera may comprise reference pixels to generate standard colors that span the color spectrum and these standards may be normalized to ambient illumination conditions to provide a reference against which a photograph may be calibrated. As another example, a user may download e.g. a home improvement store's app to his cell phone—the app comprises and/or accesses or retrieves standard values for primary or other fundamental bases of a color palette against which a photograph can be calibrated—e.g. the transduced values for “red” can be stored in memory and adjusted based on light level and then compared against the values derived from the image captured. In such a manner, a more accurate mapping may be obtained. In some embodiments a cell phone case or cover may comprise a color card.

In some embodiments, custom optical sensors including but not limited to active pixel sensors, CCDs, photodiodes, phototransistors, and custom or commercial-off-the-shelf (COTS) imagers, may be used to capture an image—i.e. to transducer patterns of light into a digital signal. In some embodiments, chemical sensors such as camera film may be used to sense the environment. In addition, image sensors and/or imagers may be used either alone or in conjunction with additional hardware and software, according to some embodiments of the instant invention, to correlate regions of captured images with colors and paints. More advanced forms of spectrometry may also be implemented in accord with some embodiments of the instant invention.

Some embodiments of the invention may comprise sensing means, including but not limited to, one or more of the following: acceleration and/or rotation sensing means, impedance sensing means, capacitive sensing means, optical sensing means, pressure sensing means, force sensing means, other electromagnetic sensing means, other electromechanical sensing means, position sensing means, proximity sensing means, ultrasonic sensing means, and chemical sensing. Examples of commercially available chemicals, reagents and scientific equipment may be found on the Fisher Scientific website, www.fishersci.com, and the Sigma-Aldrich website, www.sigmaaldrich.com. Details pertaining to these chemicals, reagents and scientific equipment may be found in their associated product descriptions, published specifications and material safety data sheets which are incorporated herein by reference.

In some embodiments of the instant invention cards may additionally comprise electronics such as lights, microphones, speakers, sensors and integrated circuits for interacting with users and/or other devices. For example, in some embodiments, lights and speakers may be added; adding light may enhance visibility and image fidelity. As one specific example of a prototype of an embodiment of the invention, battery-powered LED lights have been added to some color cards to aid in visualizing the environment.

Some embodiments of the invention may additionally comprise other hardware for performing other functions, including but not limited to communicating and/or interfacing with other circuits, components, devices, systems, networks and individuals, driving one or more display elements, processing and transmitting data, processing and transmitting power, storing and retrieving data, as well as for such miscellaneous functions as, e.g. waking and sleeping. Some embodiments may include power supplies; illustrative examples of power supplies include, but are not limited to, a battery holder, solar cells and associated charging circuitry, a plug for receiving wall power with or without associated circuitry (such as electrical transformers, rectifiers, voltage regulators, capacitors, etc.), an inductive power receiver element (such as a coil and circuitry to receive inductively coupled power), an electromechanical generator (think self-winding watch), a thermal generator (think MEMS/NEMS generators), and any other suitable source of power. Some embodiments also contain a communications module for transmitting and receiving data, including the position and/or location of other entities or markers, firmware and software updates, as well as other data (e.g., the time and date, weather conditions, etc. . . . ). A communications module may communicate wirelessly along one or more wavelengths of the electromagnetic spectrum, including but not limited to, radio waves, IR, and visible light (e.g. via radio transceiver, IR transceiver, other coded pulsed light transmissions, etc. . . . ). It may also communicate via wires which are not illustrated, for example using one of a variety of USB cables. In addition, a communications module may include speakers and/or microphones and associated circuits for receiving and decoding voice commands and for generating sounds, including but not limited to speech. It may also be integrated with a power supply—for example by capturing, harvesting and/or storing ambient or transmitted energy from an electromagnetic (“EM”) signal. Displays may comprise, but are not limited to the following: liquid crystals, thin film transistors, incandescent lights, fluorescent lights, light emitting diodes, organic light emitting diodes, lasers, fiber optics, color-changing polymers, pigmented fluids, solutions and mixtures, functionalized micro-beads, and e-inks.

Some embodiments comprise a cell phone. Some embodiments comprise a digital camera. Some embodiments comprise a laptop webcam. Some embodiments may comprise hardware that can operate in conjunction with and be capable of transmitting data to and/or receiving data from an external device, system, or network using wires and/or wireless transmission methods. Illustrative examples of external devices comprise, but are not limited to, smart and other scales, cell phones, tablet computers, PDAs, e-readers (e.g. Kindle™ and Nook™), hearing aids, laptop and desktop computers, monitors and displays, televisions, calculators, iPods™ and MP3 players, radios and stereos, watches with electrical circuits, remote controls, bar code readers, keyboards, cameras, other input devices, data acquisition systems, other electrical devices comprising, e.g., microcontrollers, programmable interface controllers, digital signal processors, memories, field programmable gate arrays, discrete circuits, and other electrical circuits and hardware, including custom application specific integrated circuits (ASIC). In some embodiments of the instant invention, refrigerators and other appliances having appropriate circuitry (e.g. microcontrollers, DSPs, transceiver modules, input devices, etc. . . . ) may comprise external devices and/or systems as defined herein. In addition, the world-wide-web, the Verizon™ wireless 4G LTE™ cellular network, and LANs are three illustrative examples of networks.

Color and captured image data may be stored in any accessible format and any form of memory, including but not limited to, written and printed media, magnetic storage media such as hard drives and tape drives and cassettes, optical storage media such as vinyl records, CDs, DVDs, and Blu Ray discs, electronic memory such as RAM, ROM, EEPROM, flash memory, and other solid state memories, analog floating gate memory, capacitive memories, chalcogenide memories, memristor-based memories, and any other existing form including human memory of individuals. In addition, there is literally an infinite number of variations to search algorithms and parameters that may be used to calibrate and/or normalize images by comparing them to standard values; examples of some such algorithms may be found in the Duda and Hart textbook referenced in this specification and incorporated herein by reference.

It is possible to perform the steps of ascertaining and/or computing data pertaining to colors and captured images in many different ways. In some embodiments, the steps of ascertaining and/or computing data pertaining to colors and captured images may be fully automated, i.e. these steps may be performed by some combination of software and/or hardware without human supervision or assistance. Some automated and other embodiments may require that a human user invoke the method in some fashion, e.g., by turning a device on, running an application, clicking a button or tapping a key, speaking a command, etc., and some automated and other embodiments may perform without a human user explicitly invoking the method. For example, a system could be programmed (in software and/or hardware) to begin operation upon the occurrence of some triggering event or events and/or the satisfaction of one or more conditions. Other embodiments of the method may be partially automated, with some aspects of the method performed by software and/or hardware, and other aspects performed by or in conjunction with one or more individuals.

The computation of data pertaining to colors and captured images may be carried out according to any number of algorithms which may in some embodiments be selected and/or programmed by a user. In some embodiments, the invention may be programmed to compute and/or assign a value or a score to colors, hues or luminances according to a formula. In some embodiments, a user may design his or her own formula and program or upload it into the invention, or select from a number of pre-defined formulas. In some embodiments of the instant invention, formulas may be fixed, programmable, adaptive and/or learning formulas that may change as a function of environmental conditions including, but not limited to, temperature, illumination, humidity, and/or air pressure, and which may also change in response to feedback, which may be generated or occur automatically, may be generated by a user, or otherwise. Formulas may be implemented in hardware, software, and or by individuals and/or entities (think chicken playing tic-tac-toe, or an AI generating optimal training regimen diets for athletes). Adaptations and/or changes to formulas may be deterministic, stochastic, and/or determined by a neural network or AI.

In addition, there are some embodiments where the steps of the invention may be performed by one or more individuals, using measured data obtained from, provided by and/or generated by hardware and/or software systems. Some embodiments in which the steps of the method are performed by one or more individuals may involve a service component, but such methods do not preclude the use of technology, for example, to measure and/or monitor data concerning colors and captured images.

In some embodiments of the invention, measured, ascertained and/or computed data, including but not limited to, the colors and captured images may be transmitted and/or received by and/or retrieved by a camera, computer and/or other system comprising software and/or hardware. In some embodiments, a system may ascertain data by one or more means including, but not limited to, measuring it, generating or observing it (e.g. pseudo-random numbers), retrieving it from memory, receiving it from users and/or entities via an input means, receiving it from external devices, software and/or hardware, including storage media; receiving it through a network such as the world-wide-web, retrieving it from publicly accessible or private disclosed records, sensing it, and/or from any other accessible source. In some embodiments of the invention, transmission and receiving may be by an existing wireless digital protocol (see below), by a custom or future wireless protocol, by analog radio frequency or other EM spectrum (including but not limited to visible, IR, and UV light) transmission, by sound, or any other means of wireless transmission, or via wires, cables, and transferable storage media such as flash drives and data cards.

Computations performed to normalize and calibrate transduced images according to various embodiments of the invention may be practiced in many ways, including for example, but not limited to, in real-time, continuously, periodically, regularly, on a schedule, at some prescribed intervals or times, with a given refresh and/or update rate, clocked, and/or asynchronously, predicated on a trigger, and/or in an event-driven fashion.

In some embodiments of the instant invention, color cards, including but not limited to included hardware and/or software, may be manufactured, fabricated, selected, and/or assembled so as to be capable of withstanding prolonged exposure to high and/or low temperatures, immersion in fluids, and/or other extreme conditions. As one specific example, some embodiments of the instant invention are fabricated to be safely laundered in a washing machine without significant damage to the embodiment or degradation in performance.

It should be noted that the figures and examples they represent are provided for illustrative purposes only and are not intended to limit the scope of the instant invention.

Although the foregoing invention has been described in some detail by way of illustration and example for purposes of clarity and understanding, it will be readily apparent to those of ordinary skill in the art in light of the teachings of this invention that certain changes and modifications may be made thereto without departing from the spirit and purview of this application or scope of the appended claims. All publications, patents, and patent applications cited herein are hereby incorporated by reference in their entirety.

I claim:

1. A color card comprising a substrate having a surface, said surface comprising one or more regions, at least one of said regions not permitting 100% of electromagnetic radiation to pass through said surface without absorbing, attenuating, reflecting or refracting said radiation.

2. The color card of claim 1, wherein at least one region of said surface reflects at least some incident electromagnetic radiation when said surface is illuminated by a light source.

3. The color card of claim 2, wherein at least some of the incident electromagnetic radiation reflected by said surface comprises visible light.

4. The color card of claim 3, wherein at least some of said reflected visible light can be perceived by a human being as comprising one or more colors.

5. The color card of claim 4, wherein the perceived colors comprise a color palette.

6. The color card of claim 5, wherein the color palette comprises the primary colors, red, yellow and blue.

7. The color card of claim 1, wherein the substrate comprises one or more of the following: adhesive, cardboard, cardstock, paper, plastic, rubber and silicon.

8. The color card of claim 1, wherein the surface and substrate have at least one coextant hole through them.

9. The color card of claim 1 further comprising a means for emitting electromagnetic radiation.

10. The color card of claim 9, wherein the means for emitting electromagnetic radiation comprises at least one light source.

11. The color card of claim 10, wherein at least one light source comprises one or more of the following: a chemically-luminescent device, an electro-luminescent device, a light emitting diode, and an organic light emitting diode.

12. The color card of claim 11, wherein a user can change the wavelengths of light emitted by one or more, or by some combination of the light sources.

13. The color card of claim 12, wherein a user can program and automate light source emissions.

14. A method for color matching comprising the steps of: acquiring at least one image of a color card disposed on or in proximity to a surface, segmenting at least one of said images into regions corresponding with one or more regions of the color card and with one or more regions of the surface, calculating data concerning properties of said segmented image regions, and employing said data to perform additional calculations in order to generate a formula for combining one or more colors to match a surface color.

15. The method of claim 14 wherein an image is acquired using a digital camera.

16. The method of claim 15 wherein the digital camera comprises a part of a cell phone, tablet computer or laptop or desktop PC.

17. The method of claim 14 wherein an image is acquired using an analog camera and transduced to digital data.

18. The method of claim 14, wherein segmentation is performed in whole or in part using registration marks.

19. The method of claim 14, wherein the calculated data comprises sampled pixel color values.
